(19) United States
(12) Patent Application Publication
(10) Pub. No.: US 2011/0025462 A1
(43) Pub. Date: Feb. 3, 2011

(54) SYSTEMS AND METHODS FOR SAVING POWER IN A DISTRIBUTED RFID SYSTEM

(75) Inventors: Miklos Stern, Woodmere, NY (US); Ed Barkan, Miller Place, NY (US); Benjamin Bekritsky, Modiin (IL)

Correspondence Address: MOTOROLA, INC.;Penny Tomko, 1303 EAST ALGONQUIN ROAD, IL01/3RD, SCHAUMBURG, IL, 60196, US

(73) Assignee: SYMBOL TECHNOLOGIES, INC., Holtsville, NY (US)

(21) Appl. No.: 12/510,830

(22) Filed: Jul. 28, 2009

(51) Int. Cl. H04Q 5/22

(52) U.S. Cl. 340/10.1

(57) ABSTRACT

Systems and methods for saving power in a distributed RFID system are provided. One RFID reader includes a RFID radio, a data communication radio, and a controller. The controller is configured to compare a current list of RFID tags responding to a current interrogation signal and a previous list of RFID tags responding to a previous interrogation signal to determine if there has been a change in RFID tags responding to the interrogation signals. The controller is also configured to command the data communication radio to transmit a signal to an external computing device if there has been the change in RFID tags, the signal indicative of the change, or not transmit the signal if there has not been a change. An RFID system includes a central computing device, multiple RFID tags, and multiple RFID readers similar to the above RFID reader.

### FIELD OF THE INVENTION

The present invention generally relates to radio-frequency identification (RFID) systems, and more particularly relates to systems and methods for saving power in a distributed RFID system.

### BACKGROUND OF THE INVENTION

There is an opportunity for RFID technology to increase productivity in various environments including, for example, retail stores. Retail stores have difficulty keeping track of their inventory on the retail floor. Inventory items are often misplaced, placed on the wrong shelf, etc., and sometimes neither the customers nor the sales people on the floor are able to locate the items. This situation leads to a loss in sales, an incorrect inventory count, and ultimately to a loss of profitability for the retailer. A currently accepted method to correct this problem is to have sales clerks read a barcode placed on every item on the floor, and to put misplaced items back on their proper shelves. This strategy is time consuming and often inaccurate.

A more recent approach, that some retailers are beginning to use, is to use RFID technology to accomplish the same task. Every item has an RFID tag on it, and sales clerks are able to walk around the store with a handheld RFID reader to take a full inventory while straightening items placed on shelves and/or “fluffing” clothing on racks. This process saves time and it is more reliable than the method of using bar codes discussed above.

A recent approach proposed a fully automated system based on RFID readers distributed throughout the sales floor. The readers are battery operated, which enables the system to be wireless. The data connection between the RFID readers and a central computer is also provided via wireless connections (e.g., WiFi radio). This approach takes inventory without human intervention. Furthermore, this can be used to map the store and can help find particular items on the sales floor. Another feature of the system is its flexibility to easily reconfigure the system, since the RFID readers can be moved at any time to any location, as there are no cables. Since the system is wireless and self-configuring, the system does not require professional installation. A drawback to this system is that the present configuration of the RFID readers is that the data communication radio consumes too much power, which shortens the life of the RFID readers.

Accordingly, it is desirable to provide systems and methods for saving power in distributed RFID systems. In addition, it is desirable to provide RFID readers that employ a method for reducing the amount of power that the data communication radio consumes during operation of the RFID reader. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

Various embodiments provide radio-frequency identification (RFID) readers. One RFID reader comprises a RFID radio, a data communication radio, and a controller coupled to the RFID radio and the data communication radio. The controller is configured to compare a current list of RFID tags responding to a current interrogation signal transmitted by the RFID radio and a previous list of RFID tags responding to a previous interrogation signal transmitted by the RFID radio to determine if there has been a change in a number of RFID tags or a change in the tags on the list responding to the current interrogation signal and the previous interrogation signal based on the comparison. The controller is further configured to command the data communication radio to transmit a signal to an external computing device if there has been a change in the number of RFID tags, the first signal indicative of the change, and decline to command the data communication radio to transmit the signal if there has not been a change in the number of responding RFID tags.

RFID systems are also provided. One RFID system comprises a central computing device, a plurality of RFID tags, and a plurality of RFID readers. Each RFID reader comprises a RFID radio configured to interrogate at least a portion of the plurality of RFID tags, a data communication radio configured to communicate with the central computing device, and a controller coupled to the RFID radio and the data communication radio. Each controller is configured to compare a current list of RFID tags responding to a current interrogation signal transmitted by the RFID radio and a previous list of RFID tags responding to a previous interrogation signal transmitted by the RFID radio, determine if there has been a change in the number of RFID tags or a change in the content of the list of RFID tags responding to the current interrogation signal and the previous interrogation signal based on the comparison, command the data communication radio to transmit a signal to the central computing device if there has been a change in the number of responding RFID tags, the signal indicative of the change, and decline to command the data communication radio to transmit the signal if there has not been a change in the number of responding RFID tags.

Also provided are methods for conserving power in an RFID reader including a data communication radio. One method comprises the steps of comparing a current list of RFID tags responding to a current interrogation signal transmitted by the RFID reader and a previous list of RFID tags responding to a previous interrogation signal transmitted by the RFID reader, and determining if there has been a change in the number of RFID tags and/or the type of RFID tag on the list responding to the current interrogation signal and the previous interrogation signal based on the comparison. The method further comprises the steps of transmitting, via the data communication radio, a signal to an external computing device if there has been a change in the list of responding RFID tags, the signal indicative of the change, and declining to transmit the signal if there has not been a change in the responding RFID tags.

### BRIEF DESCRIPTION OF THE DRAWINGS

The present invention will hereinafter be described in conjunction with the following drawing figures, wherein like numerals denote like elements, and

FIG. 1 is a block diagram of one embodiment of a radio-frequency identification (RFID) reader; and

FIG. 2 is a diagram illustrating an embodiment of an RFID system comprising a plurality of the RFID readers of FIG. 1 placed within an environment.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

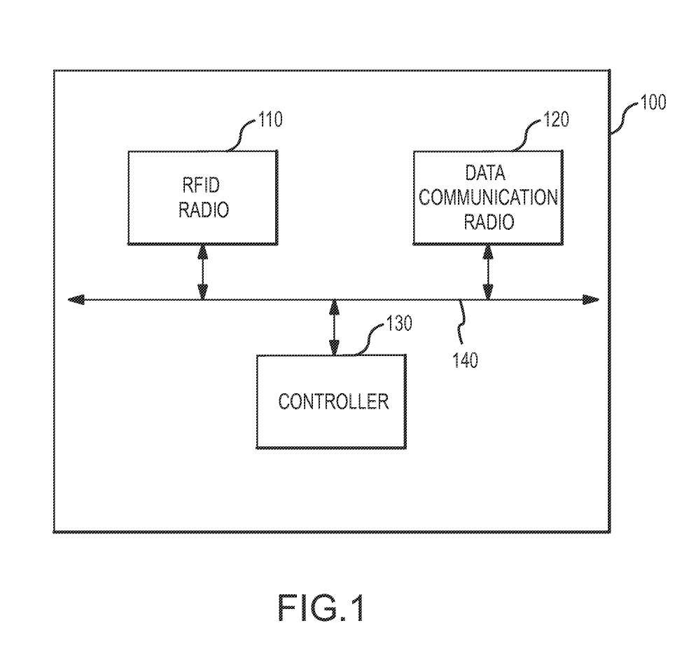

FIG. 1 is a block diagram of one embodiment of a radio-frequency identification (RFID) reader 100. At least in the illustrated embodiment, RFID reader 100 comprises a RFID radio 110, a data communication radio 120, and a controller 130 coupled to and in communication with each other via a bus 140 (e.g., a wired and/or wireless bus).

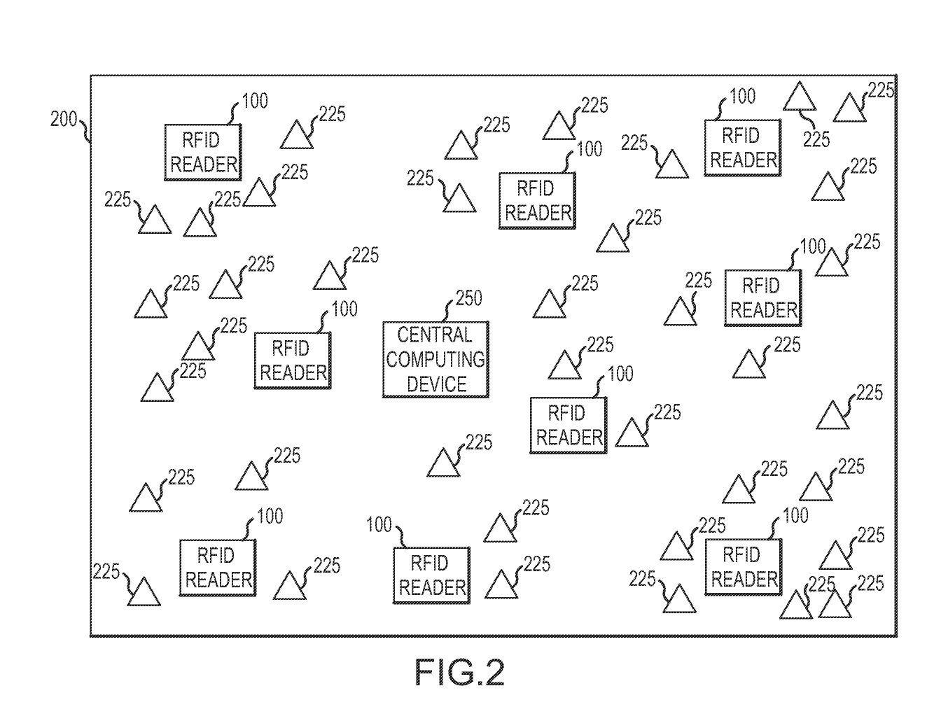

RFID radio 110 may be any RFID radio known in the art or developed in the future capable of transmitting interrogation signals to and receiving signals from one or more RFID tags (see e.g., RFID tags 225 in FIG. 2, below) in response to the interrogation signals. Notably, various embodiments of RFID reader 100 contemplate that RFID radio 110 may be replaced with a transceiver or a separate combination of a transmitter and a receiver. As such, the term “RFID radio” as used herein also includes transceivers and combinations of a transmitter and a receiver, as well as RFID radios.

Data communication radio 120 may be any radio known in the art or developed in the future the enables RFID reader 100 to transmit signals to and receive signals from one or more central computing devices (see e.g., central computing device 250 in FIG. 2, below). In one embodiment, data communication radio 120 is a Wi-Fi radio. In another embodiment, data communication radio 120 is a Zigbee radio (i.e. a radio using the IEEE 802.15.4 standard). In other embodiments, data communication radio 120 may be a radio using Bluetooth® technology, a WAN (e.g., GPRS, 3G, etc.), and/or the like radios.

Controller 130, in one embodiment, is configured to command RFID radio 110 to intermittently transmit interrogation signals to determine if any RFID tags are within a predetermined distance of RFID reader 100. Controller 130 is further configured to receive, via RFID radio 110, signals having identification data from RFID tags responding to the various interrogation signals. Furthermore, controller 130 is configured to store a list of RFID tags indicative of the number and type of RFID tags that respond to each of the various interrogation signals. That is, various RFID tags may be associated with different products and include different identification data. In this embodiment, controller 130 is configured to differentiate between the RFID tags associated with the various different products based on the different identification data and store the number of RFID tags associated with each respective product that respond to a particular interrogation signal in the list.

Controller 130, in a further embodiment, is configured to compare a current list of RFID tags responding to a recently-transmitted interrogation signal and a previous list of RFID tags that responded to a previously-transmitted interrogation signal to determine if there has been a change in the number, type, and/or tags IDs of RFID tags within the predetermined distance of RFID reader 100. Specifically, controller 130 is configured to compare the current list of RFID tags to the previous list of RFID tags to determine if there are RFID tags responding to the recently-transmitted interrogation signal that did not respond to the previously-transmitted interrogation signal (i.e., new or newly detected RFID tags). Furthermore, controller 130 is configured to compare the current list of RFID tags to the previous list of RFID tags to determine if there are RFID tags not responding to the recently-transmitted interrogation signal that did respond to the previously-transmitted interrogation signal (i.e., RFID tags removed from the environment). In addition, controller 130 is configured to replace the previous list of RFID tags responding to the previously-transmitted interrogation signal with the current list of RFID tags that responded to the currently-transmitted interrogation signal such that the current list of RFID tags is a previous list of RFID tags for a future comparison.

Furthermore, controller 130 is configured to transmit a signal, via data communication radio 120, to a central computing device (see e.g., central computing device 250 in FIG. 2, below) indicating the change in the number, type, and/or tag IDs of RFID tags if there has been a change in the RFID tags. Specifically, controller 130 is configured to indicate to the central computing device a change in the overall number of RFID tags and/or a change in the number of RFID tags related to specific items in inventory. For example, if the list of RFID tags associated with product A has changed and the list of RFID tags associated with product B remains unchanged, controller 130 will transmit a signal to the central computing device indicating the change in the list of RFID tags associated with product A. If the list of RFID tags associated with both product A and product B have changed, controller 130 will transmit a signal to the central computing device indicating the change in the list of RFID tags associated with both product A and product B.

Controller 130 is also configured to not transmit a signal to the central computing device if there has not been a change in the list of RFID tags within the predetermined distance of RFID reader 100. For example, if the list of RFID tags associated with both product A and product B remain unchanged, controller 130 will not transmit a signal to the central computing device. In this manner, RFID reader 100 consumes less power than if RFID reader 100 transmitted a signal to the central computing device indicative of the list of RFID tags responding to each interrogation signal each time RFID reader 100 transmitted an interrogation signal.

In another embodiment, controller 130 is configured to transmit a signal, via data communication radio 120, indicative of the health of RFID reader 100 to the central computing device if controller 130 has not transmitted a signal to the central computing device within a predetermined amount of time. In other words, controller 130 is configured to periodically “check in” with the central computing device to notify the central computing device that RFID reader 100 is, for example, still on-line, operating properly, and/or still has sufficient power to operate.

Multiple RFID readers 100 may be placed within an environment to create an inventory control system. FIG. 2 is one embodiment of an RFID system 200 comprising multiple RFID tags 225 and multiple RFID readers 100 that are configured to monitor the number of RFID tags 225 within environment 200 and report the list of responding RFID tags 225 to central computing device 250.

RFID tags 225 may be any RFID tag known in the art or developed in the future. That is, RFID tags 225 may be passive RFID tags, active RFID tags, and/or any other type of RFID tag.

Central computing device 250 may be any computing device known in the art or developed in the future capable of communicating with RFID readers 100, storing the inventory data transmitted from RFID readers 100, and keeping track of the inventory changes in environment 200. That is, central computing device 250 in configured to maintain and update an inventory database based on the changes reported by the various RFID readers 100.

At least in the embodiment illustrated in FIG. 2, each RFID reader 100 remains in a relatively fixed location. RFID readers 100 are placed throughout environment 200 in manner that enables substantially all of environment 200 to be covered by an interrogation signal from an RFID reader 100 so that an accurate inventory can be taken at each issuance of an interrogation signal from RFID readers 100.

During operation, each RFID reader 100 transmits intermittent interrogation signals to which RFID tags 225 within the predetermined range of each respective RFID reader 100 respond. Each RFID reader 100 differentiates between the various RFID tags and reports any changes in inventory (i.e., the change in a list of responding RFID tags 225) to central computing device 250. If there are no changes in inventory determined by a particular RFID reader 100, that particular RFID reader does not report to central computing device 250 so that the particular RFID reader 100 can conserve power (unless the particular RFID reader 100 is performing its periodic check in with central computing device 250).

While the above embodiments have been described as comparing the number, type, and/or RFID tag IDs of RFID tags that respond to two consecutive interrogation signals transmitted by RFID readers 100; various other embodiments provide other reporting schemes. For example, RFID reader(s) 100 may transmit several interrogation signals within a relatively short period a time and use an average of the number and/or type of RFID tags responding to the several recently-transmitted interrogation signals as a point of comparison to the average of several previously-transmitted interrogation signals transmitted at an earlier time. Similar to the embodiments discussed above, these RFID readers 100 will only transmit a signal to the central computing device indicating a change in inventory only if there have been a change reflected in the difference between the two averages. As such, the present invention is not limited to comparing two consecutive interrogation signals, but instead includes differences determined at two different periods of time.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. A radio-frequency identification (RFID) reader, comprising:
a RFID radio;
a data communication radio; and
a controller coupled to the RFID radio and the data communication radio, the controller configured to:
compare a current list of RFID tags responding to a current interrogation signal transmitted by the RFID radio and a previous list of RFID tags responding to a previous interrogation signal transmitted by the RFID radio;
determine if there has been a change in RFID tags responding to the current interrogation signal and the previous interrogation signal based on the comparison;
command the data communication radio to transmit a first signal to an external computing device if there has been the change in RFID tags, the first signal indicative of the change; and
decline to command the data communication radio to transmit the first signal if there has not been the change RFID tags.

2. The RFID reader of claim 1, wherein the controller is further configured to command the data communication radio to transmit a second signal to the external computing device if there has not been the change in RFID tags within a predetermined period of time, the second signal indicative of a health of the RFID reader.

3. The RFID reader of claim 2, wherein the data communication radio is a Wi-Fi radio.

4. The RFID reader of claim 2, wherein the data communication radio is a Zigbee radio.

5. The RFID reader of claim 1, further comprising:
a memory coupled to the controller, wherein the controller is further configured to:
command the RFID radio to transmit the previous interrogation signal,
receive, via the RFID radio, first identification data from one or more RFID tags responding to the previous interrogation signal,
determine the previous list of RFID tags based on the received first identification data, and
store the previous list of RFID tags in the memory.

6. The RFID reader of claim 5, wherein the controller is further configured to:
command the RFID radio to transmit the current interrogation signal;
receive, via the RFID radio, second identification data from one or more RFID tags responding to the current interrogation signal; and
determine the current list of RFID tags based on the received second identification data.

7. The RFID reader of claim 6, wherein the controller is further configured to replace the previous list of RFID tags with the current list of RFID tags in the memory after the comparison such that the current list of RFID tags is the previous list of RFID tags for a future comparison.

8. A radio-frequency identification (RFID) system, comprising:
a central computing device;
a plurality of RFID tags; and
a plurality of RFID readers, each RFID reader comprising:
a RFID radio configured to interrogate at least a portion of the plurality of RFID tags,
a data communication radio configured to communicate with the central computing device, and
a controller coupled to the RFID radio and the data communication radio, wherein each controller is configured to:
compare a current list of RFID tags responding to a current interrogation signal transmitted by the RFID radio and a previous list of RFID tags responding to a previous interrogation signal transmitted by the RFID radio,
determine if there has been a change in RFID tags responding to the current interrogation signal and the previous interrogation signal based on the comparison,
command the data communication radio to transmit a first signal to the central computing device if there has been the change in RFID tags, the first signal indicative of the change, and
decline to command the data communication radio to transmit the first signal if there has not been the change in RFID tags.

9. The RFID system of claim 8, wherein each controller is further configured to command the data communication radio to transmit a second signal to the central computing device if there has not been the change in RFID tags within a predetermined period of time, the second signal indicative of a health of a respective RFID reader associated with each controller.

10. The RFID system of claim 9, wherein each radio is a Wi-Fi radio.

11. The RFID system of claim 10, wherein the data communication radio is a Wi-Fi radio.

12. The RFID system of claim 8, wherein each RFID reader further comprises:
a memory coupled to the controller, wherein the controller is further configured to:
command the RFID radio to transmit the previous interrogation signal,
receive, via the RFID radio, first identification data from one or more RFID tags responding to the previous interrogation signal,
determine the previous list of RFID tags based on the received first identification data, and
store the previous list of RFID tags in the memory.

13. The RFID system, of claim 12, wherein each controller is further configured to:
command the RFID radio to transmit the current interrogation signal;
receive, via the RFID radio, second identification data from one or more RFID tags responding to the current interrogation signal; and
determine the current list of RFID tags based on the received second identification data.

14. The RFID reader of claim 13, wherein each controller is further configured to replace the previous list of RFID tags with the current list of RFID tags in the memory after the comparison such that the current list of RFID tags is the previous list of RFID tags for a future comparison.

15. A method for conserving power in a radio-frequency identification (RFID) reader including a data communication radio, comprising the steps of:
comparing a current list of RFID tags responding to a current interrogation signal transmitted by the RFID reader and a previous list of RFID tags responding to a previous interrogation signal transmitted by the RFID reader;
determining if there has been a change in RFID tags responding to the current interrogation signal and the previous interrogation signal based on the comparison;
transmitting, via the data communication radio, a first signal to an external computing device if there has been the change in RFID tags, the first signal indicative of the change; and
declining to transmit the first signal if there has not been the change in RFID tags.

16. The method of claim 15, further comprising the step of transmitting, via the data communication radio, a second signal to the external computing device if there has not been the change in RFID tags within a predetermined period of time, the second signal indicative of a health of the RFID reader.

17. The method of claim 16, wherein the data communication radio is a Wi-Fi radio and the step of transmitting the first signal comprises the step of transmitting the first signal via the Wi-Fi radio, and the step of transmitting the second signal comprises the step of transmitting the second signal via the Wi-Fi radio.

18. The method of claim 15, further comprising the steps of:
transmitting the previous interrogation signal from the RFID reader;
receiving first identification data from one or more RFID tags responding to the previous interrogation signal;
determining the previous list of RFID tags based on the received first identification data; and
storing the previous list of RFID tags.

19. The method of claim 18, further comprising the steps of:
transmitting the current interrogation signal from the RFID reader;
receiving second identification data from one or more RFID tags responding to the current interrogation signal; and
determining the current list of RFID tags based on the received second identification data.

20. The method of claim 19, further comprising the step of replacing the previous list of RFID tags with the current list of RFID tags after the comparison such that the current list of RFID tags is the previous list of RFID tags for a future comparison.
